(19) United States
(12) Patent Application Publication
(10) Pub. No.: US 2018/0203231 A1
(43) Pub. Date: Jul. 19, 2018

(54) LENSLET NEAR-EYE DISPLAY DEVICE

(71) Applicant: Microsoft Technology Licensing, LLC, Redmond, WA (US)

(72) Inventors: Eliezer GLIK, Seattle, WA (US); Cynthia BELL, Kirkland, WA (US); Bernard C. KRESS, Redwood City, CA (US)

(21) Appl. No.: 15/498,349

(22) Filed: Apr. 26, 2017

Related U.S. Application Data
(60) Provisional application No. 62/446,280, filed on Jan. 13, 2017.

(51) Int. Cl. G02B 27/01; G02B 3/00; G06F 3/01

(52) U.S. Cl. CPC G02B 27/0172; G02B 3/0043; G02B 2027/014; G02B 2027/013; G02B 2027/0138; G06F 3/013

(57) ABSTRACT

The disclosed embodiments include a display device including substantially transparent substrates, a lenslet array including substantially transparent lenslets disposed between the plurality of transparent substrates, and light sources disposed between the substantially transparent substrates. The light sources are operable to emit light towards respective lenslets of the lenslet array, and the lenslet array is configured to render a digital image by reflecting the emitted light towards the light sources.

This application claims the benefit of U.S. provisional patent application No. 62/446,280, filed on Jan. 13, 2017, which is incorporated herein by reference in its entirety.

### BACKGROUND

There are a variety of virtual reality or augmented reality display systems that seamlessly blend digital content with the physical world. For example, a head-mounted display (HMD) device can include transparent display elements that enable users wearing the HMD device to see concurrently both the physical world around them and digital content displayed by the HMD device. An HMD device is more generally referred to as a type of near-eye display (NED) device that can enable a mixed reality experience by a user wearing the HMD device. In general, an NED device is at least somewhat transparent to seamlessly blend the digital world displayed by the NED device with the physical world seen through the NED device. A typical NED device includes components such as light sources (e.g., display pixels), sensors, and processing electronics. An HMD device can generate images (e.g., holographic images) in accordance with the environment of the user wearing the HMD device, based on measurements and calculations determined from the components of the HMD device.

The field of view (FOV) of a typical NED device is limited. For example, an HMD device can include display devices positioned to display images in front of the user's eyes (e.g., one for each eye). However, the collective FOV of the display devices does not include the user's peripheral vision. Thus, typical HMD devices fail to create a fully immersive experience for users wearing the HMD devices. One approach to addressing these drawbacks is to use display devices that wrap around a user's eyes to collectively expand the user's FOV. However, increasing the size of the display devices is impractical because typical display devices are already relatively complex, consume considerable amounts of resources, and are expensive. Increasing the size of display devices is not only impractical and cost-prohibitive, but is also excessive because a user's peripheral vision is relied upon less to perceive the user's environment. Further, larger display devices are not suitable for particular applications such as HMD devices because their increased bulkiness and weight would make the HMD device uncomfortable to wear.

### SUMMARY

The techniques introduced here include at least one display device. Embodiments of the display device include substantially transparent substrates, a lenslet array including substantially transparent lenslets disposed between the transparent substrates, and light sources disposed between the substantially transparent substrates. The light sources are operable to emit light towards respective lenslets of the lenslet array, and the lenslet array is configured to render a digital image by reflecting the emitted light towards the light sources.

Having a reflective object would normally hinder the see-through performance since a reflective surface would reflect light rays. In this case, a partially reflective surface is employed, i.e., one which still transmits at least some light. Since the partially reflective surface is index matched, distortion from the optical power of the surface is minimized or even eliminated, since in the transmission case there is no effective lens power or index change. Therefore, the reflective lenslets effectively only work in reflection, but light can transmit through the lenslets unaltered.

In some embodiments, a HMD device includes a first display device and a second display device configured to augment the first display device. The second display device includes substantially transparent substrates, a lenslet array including substantially transparent lenslets disposed between the plurality of transparent substrates, and light sources disposed between the substantially transparent substrates. The light sources are operable to emit light towards respective lenslets of the lenslet array, and the lenslet array is configured to render digital content by reflecting the emitted light towards the light sources.

In some embodiments, an HMD device includes a substantially transparent main display device, and a substantially transparent peripheral display device configured to extend a field of view of the main display device to include a peripheral view. The substantially transparent peripheral display device includes a lenslet array including lenslets that are electrically switchable to activate optical properties and deactivate the optical properties, where a lenslet is substantially transparent when deactivated. The peripheral display device also includes inorganic light emitting diodes (ILEDs) configured to emit light towards respective lenslets, where the ILEDs are sufficiently spaced apart such that the display is semi-transparent. Further, the lenslet array is configured to render a digital image when activated and receiving emitted light from the ILEDs.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 is a block diagram illustrating an example of an environment in which the disclosed embodiments can be implemented.

FIG. 2 is a schematic side view of a display device according to an embodiment.

FIG. 3A is a schematic side view of a display device that has a transmissive configuration where light sources emit light towards a user's eye and a lenslet array propagates the emitted light to the eye according to an embodiment.

FIG. 3B illustrates a path of light from a light source (shown as a point source) to a user's eye via a lenslet of the display device of FIG. 3A.

FIG. 4 is a schematic side view of a display device that has a reflection configuration where light sources emit light away from a user's eye and a lenslet array reflects the emitted light back towards the eye according to another embodiment.

FIG. 5 is a schematic side view of a display device that has a reflection configuration and implements an eye box according to an embodiment.

FIG. 6 is a graph showing properties of different types of lenses which could be implemented in the disclosed embodiments.

FIG. 7A depicts paths taken by light emitted by light sources and reflected off corresponding lenslets towards a user's eye.

FIG. 7B depicts an example of an eye-box created by two replication elements of FIG. 7A.

FIG. 7C similarly depicts the eye-box created from two replication elements of FIG. 7B.

### DETAILED DESCRIPTION

In this description, references to “an embodiment,” “one embodiment” or the like mean that the particular feature, function, structure or characteristic being described is included in at least one embodiment introduced herein. Occurrences of such phrases in this specification do not necessarily all refer to the same embodiment. On the other hand, the embodiments referred to herein are also not necessarily mutually exclusive.

The following description generally assumes that a “user” of a display device is a human. However, that a display device of the disclosed embodiments can potentially be used by a user that is not human, such as a machine or an animal. Hence, the term “user” can refer to any of those possibilities, except as may be otherwise stated or evident from context. Further, the term “eye” can refer to any optical receptor such as a human eye, an animal eye, or a machine-implemented optical sensor designed to detect an image in a manner analogous to a human eye.

Virtual reality or augmented reality enabled head-mounted display (HMD) devices may include one or more transparent displays that enable users to see concurrently both the physical world around them and displayed digital content. An HMD device is a type of wearable near-eye display (NED) device that includes light sources, optical elements, sensors, processing electronics and other components for rendering digital images that can be viewed concurrently with a user's physical environment. For example, a HMD device may include displays that render digital images (e.g., holographic images) in accordance with the environment of a user wearing the HMD device, based on measurements and calculations determined by components of the HMD device. For example, the HMD device may have a depth sensing system that resolves distance between the HMD device worn by a user and physical objects in the user's vicinity. The HMD device can generate digital images based on, for example, resolved distances so that holographic objects appear at specific locations relative to physical objects in the user's environment.

The disclosed embodiments include a display device, which can also be referred to as a display. The disclosed display devices can include any type of display device such as a NED device, and any particular type of NED device such as a HMD device. Further still, the disclosed display device may be a component of a display system. For example, a HMD device can include one or more display devices operable to display digital images overlaid on the view of a user's eyes when the user wears the HMD device. Specifically, a display device can be positioned directly in front of each eye of the user wearing the HMD device, to project digital images toward the user's eyes. With such a configuration, the digital images generated by the HMD device can be overlaid on the user's 3D view of the physical world to create an augmented reality. In some cases, light from the external environment can be selectively blocked from the HMD device such that the user can experience a virtual reality view rather than an augmented reality view.

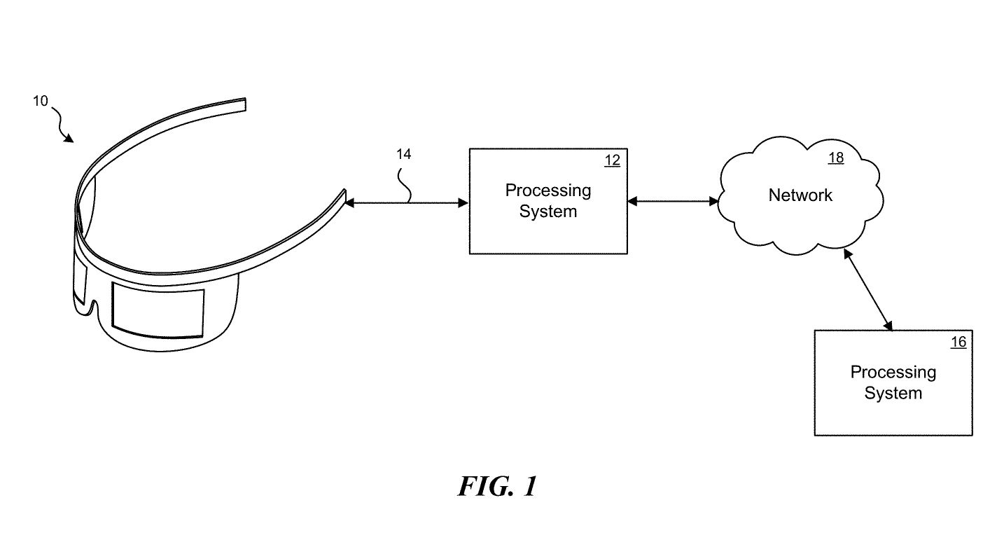

FIGS. 1 through 7 and related text describe certain embodiments of display devices in the context of NED devices and, more particularly, peripheral NED devices that augment main display devices to extend a user's field of view (FOV) by including a user's peripheral view. However, the disclosed embodiments are not limited to peripheral NED devices and have a variety of possible applications for imaging systems including entertainment systems, vehicle display systems, or the like. For example, the disclosed embodiments may include non-NED devices, and may be used as main display devices rather than peripheral display devices. All such applications, improvements, or modifications are considered within the scope of the concepts disclosed herein.

FIG. 1 is a block diagram illustrating an example of an environment in which the disclosed embodiments can be implemented. In the illustrated example, the HMD device 10 is configured to communicate data to and from a processing system 12 through a connection 14, which can be a wired connection, a wireless connection, or a combination thereof. In other use cases, the HMD device 10 may operate as a standalone device. The connection 14 can be configured to carry any kind of data, such as image data (e.g., still images and/or full-motion video, including 2D and 3D images), audio, multimedia, voice, and/or any other type(s) of data.

The processing system 12 may be, for example, a game console, personal computer, tablet computer, smartphone, or other type of processing device. The connection 14 can be, for example, a universal serial bus (USB) connection, Wi-Fi connection, Bluetooth or Bluetooth Low Energy (BLE) connection, Ethernet connection, cable connection, digital subscriber line (DSL) connection, cellular connection (e.g., 3G, LTE/4G or 5G), or the like, or a combination thereof. Additionally, the processing system 12 may communicate with one or more other processing systems 16 via a network 18, which may be or include, for example, a local area network (LAN), a wide area network (WAN), an intranet, a metropolitan area network (MAN), the global Internet, or combinations thereof.

The HMD device 10 can incorporate the features introduced herein according to certain embodiments. For example, the HMD device 10 can be an assembly having a chassis that structurally supports display elements, optics, sensors and electronics. The chassis of the HMD device 10 can be formed of, for example, metal, molded plastic, and/or a polymer. The HMD device 10 can include left and right display devices configured to display images overlaid on the user's view of the physical world by, for example, projecting light towards the user's eyes. The HMD device 10 may include various fixtures (e.g., screw holes, raised flat surfaces, etc.) to which the display devices, sensors, and other components can be attached.

The HMD device 10 includes electronics circuitry (not shown) to control and synchronize operations of display devices, and to perform associated data processing functions. The circuitry may include, for example, one or more processors and one or more memories. The HMD device 10 can provide surface reconstruction to model the user's environment. With such a configuration, images generated by the HMD device 10 can be properly overlaid on the user's 3D view of the physical world to provide a virtual or augmented reality. In other embodiments the aforementioned components may be located in different locations on the HMD device 10. Some embodiments may omit some of the aforementioned components and/or may include additional components not discussed above nor shown in FIG. 1 for the sake of brevity and/or because they are well known to persons skilled in the art.

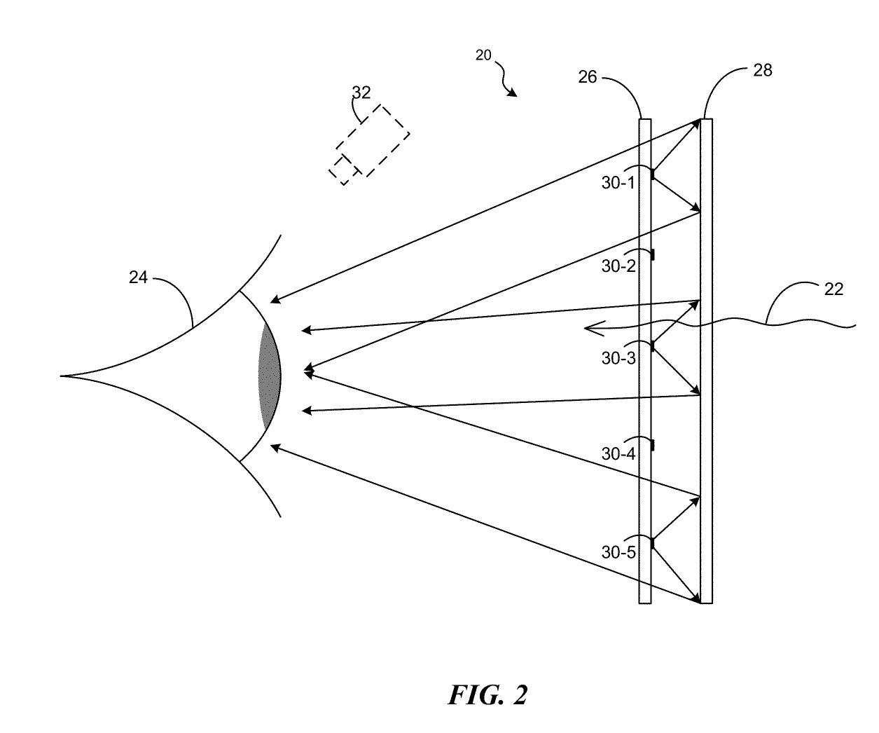

FIG. 2 is a schematic side view of a display device according to an embodiment. The display device 20 is relatively thin and is at least somewhat transparent to visible light. The display device 20 may be formed of glass, plastic, or any other potentially transparent material. The degree of transparency of the display device 20 may vary from semi-transparent to substantially transparent depending on the materials, design, and arrangement of components used to form the display device 20. As used herein, the term “substantially” refers to at least a majority.

As shown, the light 22 can propagate substantially unaltered (e.g., reflected, collimated, or absorbed) from a user's environment through the display device 20 to reach the user's eye 24. As a result of this configuration, the user's eye 24 can perceive objects in the user's environment by seeing through the display device 20. Accordingly, the display device 20 can create an augmented reality experience by superimposing digital images on a user's view of the physical world. In other words, a digital image may be superimposed on the physical world as perceived by the user's eye 24. The display device 20 includes a light emitting substrate 26 and a holographic substrate 28, which can be substantially transparent to certain light spectrums (e.g., have specified limited ranges).

The display device 20 includes light sources 30 disposed between the light emitting substrate 26 and the holographic substrate 28. For example, the light sources 30 can be affixed on the inside of the light emitting substrate 26 with an adhesive. The light sources 30 are sufficiently spaced apart to allow the light 22 to propagate through the light emitting substrate 26 to the user's eye 24. Examples of a light source include a transparent organic light emitting diode (OLED) or an inorganic light emitting diode (ILED), which is smaller, more efficient, and less susceptible to damage from moisture compared to an OLED. The light sources 30 are operable to emit light in a direction away from the user's eye 24, towards the holographic substrate 28. In some embodiments, the light sources 30 are arranged as pixels in display areas of the light emitting substrate 26 that can emit light when activated. The light sources 30 may have any shape (e.g., rectangular-shaped) and be arranged as a 2D array.

The holographic substrate 28 has a surface used to render a hologram when light from the light sources 30 is projected onto the surface. More specifically, the holographic substrate 28 can be formed of one or more optical elements that can be used to encode a digital image onto the surface of the holographic optical element 28. When light from the light sources 30 is projected onto the surface having the encoded digital image, a hologram of the encoded digital image is perceived by the user's eye 24. For example, a holographic image can be rendered by projecting collimated light from the display device 20 to the user's eye 24, where it is focused by the user's eye 24 to optical infinity. The combination of light source 30 and optical elements of the holographic substrate 28 can be adapted to render a digital image on a desired plane.

In certain embodiments, the holographic substrate 28 has a reflection spectrum and a transmission spectrum, which can be non-overlapping, partially overlapping , or completely overlapping. In some embodiments, the reflection and/or transmission spectrums can be specified to limited ranges. For example, the optical elements of the holographic substrate 28 may only reflect light within its reflection spectrum, which may correspond to the light emitted by the light sources 30. Further, any light within the transmission spectrum would propagate through the holographic substrate 28 without being substantially altered. For example, the transmission spectrum may include visible light from the physical world to allow that light to propagate through the display device 20.

In some embodiments, each light source 30 illuminates a display area of the light emitting substrate 26. Each display area can have a corresponding optical element of the holographic substrate 28. Hence, a single light source 30 can be in the focal plane of a single respective optical element. In general, each optical element of the holographic substrate 30 may condition and/or redirect the light emitted by a respective light source 30 towards the user's eye, to achieve a desired effect. To “condition” light refers to changing the orientation of light rays relative to each other. For example, to condition light may affect divergence or convergence of light rays to collimate or de-collimate the light. To “redirect” light refers to changing the direction of light (e.g., reflect, turn, or steer). Hence, an optical element can reflect and collimate light emitted by a respective light source.

In some embodiments, the light sources 30 can have a certain emission spectrum, and/or the light emitting substrate 26 may have a certain transmission spectrum. As such, the light sources 30 may only emit light within a specified emission spectrum and the light emitting substrate 26 may only transmit light within a specified transmission spectrum. The emission spectrum and transmission spectrum can have varying degrees of overlap depending on a particular application. For example, the emission spectrum may equal the transmission spectrum of the light emitting substrate 26 such that the light emitted by the light sources 30, and reflected off the holographic substrate 28, is transmitted through the light emitting substrate 26, and light outside the emission spectrum is blocked from the user's eye 24.

In some embodiments, the display device 20 may include a controller (not shown) operable to activate, deactivate, and/or tune light emitted by the light sources 30 to render the digital images perceived by the user's eye 24. For example, the controller can move the rendering of a digital image to different display areas of the light emitting substrate 26, or tune the light emitted by the light sources 30.

In some embodiments, the display device 20 may include an eye tracker 32. In some embodiments, the eye tracker 32 can be a standalone camera located on the side of a display device or embedded in the display device 20 itself. The eye tracker 32 can capture images of the pupil of the user's eye 24. The captured images can be used to generate a position signal representing a position of the pupil. Therefore, the eye tracker 32 can track the position of the user's pupil.

The controller can cause the display device 20 to render a digital image based on the position signals generated by the eye tracker 32 such that the light of the rendered image can track the position of the user's pupil. In particular, the eye tracker 32 allows the display device 20 to dynamically set its exit pupil based on the location of the user's pupil such that the light emitted by the display device 20 correctly propagates in the direction to the user's eye 24. Thus, the user's eye continuously receives the light emitted by the light source 30 even when the eye 24 is moving. Accordingly, the position of the exit pupil can be set to the position of the user's pupil electronically and optically rather than by mechanically moving parts.

A combination of display devices like display device 20 can be used to provide an expanded field-of-view (FOV) to a user's eyes. For example, an HMD device can have a main display device for each of the user's eyes. Each display device has a limited FOV, which is much smaller than a human eye (e.g., can extend about 120 degrees from the center to the side). When a user wears the HMD device, the user's eye typically cannot perceive a digital object displayed on the periphery of the user's FOV. However, each main display device can be augmented with a peripheral display device on each side of the HMD device to accommodate a user's peripheral view.

Thus, the HMD device can have a combination of main and peripheral display devices that collectively expand the FOV of a user wearing the HMD device. By augmenting the main display devices with peripheral display devices, a user can have a more immersive experience because of the expanded FOV. However, merely adding more display devices to an HMD device may be impractical because each display device is relatively complex, consumes more than a modest amount of computing resources, and can be cost-prohibitive. Moreover, users rely far less on their peripheral view such that using the same main display devices as peripheral display devices can be excessive.

To address these drawbacks, the disclosed embodiments include display devices that can be more suitable as peripheral display devices. For example, some disclosed embodiments of display devices may have adequate resolution as peripheral display devices but inadequate resolution as main display devices. Hence, lower-resolution peripheral display devices can be combined with higher-resolution main display devices to increase a user's FOV, and reduce overall cost and complexity of the system while increasing overall efficiency. However, the disclosure is not so limited. Instead, embodiments can use any combination of the disclosed display devices. For example, some applications may use a combination of only lower-resolution display devices.

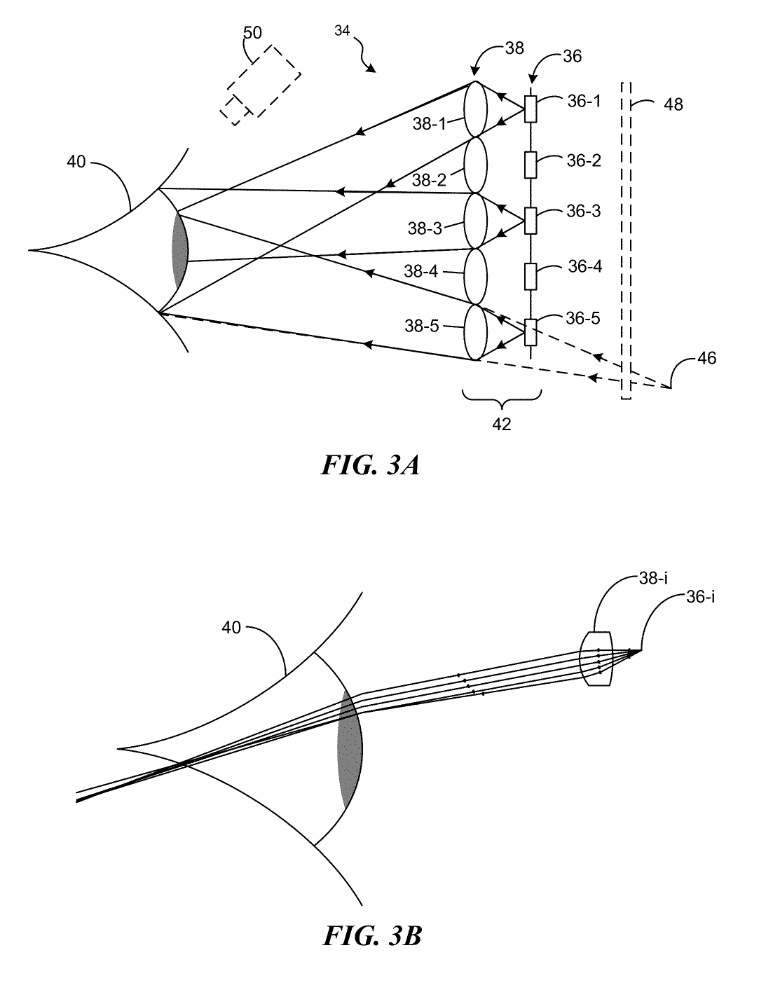

FIG. 3A is a schematic side view of a display device that has a transmissive configuration where light sources emit light towards a user's eye and a lenslet array propagates the emitted light to the eye according to an embodiment. FIG. 3A shows only some components to aid in understanding the illustrated embodiment and omits components that are known to persons skilled in the art and/or described elsewhere in this disclosure. The display device 34 can be a low resolution peripheral display device that extends a user's FOV when combined with another display device included in an HMD device worn by the user. The display device 34 can be relatively thin and is at least somewhat transparent. The display device 34 includes light sources 36 and a lenslet array 38. The light sources 36 and lenslet array 38 can be arranged by, for example, gluing or bonding to the display device 34.

The light sources 36 can emit light in a direction toward a user's eye 40 when the HMD device, including the display device 34, is worn by the user. The light sources 36-1 through 36-5 are sufficiently spaced apart to allow light to propagate from a user's external environment to the lenslet array 38. In some embodiments, each light source 36 is a transparent OLED or ILED. The display device 34 may include any number of light sources that form a 2D array. The light sources 36 can be switched “on” to emit light and switched “off” to stop emitting light.

The display device 34 may include distinct display areas formed from the light sources 36 as display pixels that can be turned on to display an image. The display areas may include multiple pixels sufficiently spaced apart to allow light to propagate to the lenslets 38 from an exterior environment. The pixels may be in the focal plane of respective lenslets. In some cases, the pixels are rectangular-shaped across a 2D pixel array. The pixel array may lie in a plane and/or curved area.

The individual lenslets 38-1 through 38-5 can be, for example, micro-lenses. More generally, a “lenslet” refers to a relatively small lens that is part of a lenslet array. In certain embodiments, the lenslet array can be a periodic array or an aperiodic array, and can be made from conventional grinded/polished surfaces, or can be made diffractive or switching diffractive. In certain embodiments, each of the lenslets 38 can have the same focal length. Although FIG. 3A only illustrates a few lenslets, the display device 34 may include any number of lenslets that form a 2D array. In some embodiments, the display device 34 includes a lenslet 38 for each light source 36. The physical separation 42 between the light sources 36 and the lenslets 38 may equal the focal length of the lenslets 38. As such, the user's eye 40 can perceive a displayed image rendered by the light sources 36 and turned and focused by the lenslet array 38.

In some embodiments, the lenslet array 38 may use Bragg lenses, Fresnel lenses, or any other suitable optics that disposed on top of a 2D display of the light sources 36. For example, a suitable pixel display can be a transmissive OLED or backlit LCD display. The lenslet array 38 can turn and focus the light emitted by the light sources 36 into semi-collimated rays towards the user's eye 40. Thus, the lenslet array 38 can project digital images toward the user's eye 40. For example, FIG. 3B illustrates a path of light from a light source 36 (shown as a point source) to a user's eye 40 via a lenslet 38 of the display device 34. In particular, the light emitted by the light source 36 propagates through the lenslet 38 and is at least semi-focused on the retina of the user's eye 40, where it is focused to optical infinity.

As such, a digital image can be rendered by using the light sources 36 and respective lenslets 38, which collimate and redirect the emitted light of the displayed image towards the user's eye 40. The light emitted by the light sources 36 can be directed by respective lenslets 38 in a substantially parallel manner so that the digital image can be perceived by the user's eye 40 as being displayed at optical infinity. Consequently, the user's eye 40 can perceive the digital image being displayed by using the light sources 36.

In some embodiments, the lenslet array 36 is switchable. That is, the lenslet array 36 can be electrically activated or deactivated. When deactivated, the lenslet array 36 is substantially optically flat such that light propagating through the lenslets 36-1 through 36-5 is substantially unaffected. When activated, the lenslet array 36 can condition and/or redirect light. Again, to “condition” light refers to changing the orientation of light rays relative to each other. For example, to condition light may affect divergence or convergence of light rays to collimate or de-collimate the light. To “redirect” light refers to changing the direction of light. Thus, light propagating through an active lenslet can be conditioned and/or redirected to the user's eye 40.

In some embodiments, the lenslet array 36 may use the same backplane as the OLED or LCD display such that a pixel and corresponding lenslet is simultaneously activated, which simplifies drive requirements. Hence, the lenslet array 38 would not be visible when the light source 36 is not emitting light. In some embodiments, each color of a digital image could have its own switching lenslet due to the spectral bandwidth of the lenslet. In this case, the appropriate lenslet would be on for the duration of the appropriate color of light. Note that the angular spread of a light source may be large and angular bandwidth of the hologram may be small, which may affect efficiency.

An approach to obtain a switchable lenslet array is to use a fluid-filled structure that can be activated to form the lenslet array. In particular, the fluid-filled structure can include a thin membrane stretched over a grid-shaped frame on a substrate, which creates a cavity that is filled with fluid. The membrane of the structure bows to form the lenslet array when pressure is applied. In contrast, the structure remains inactive when no pressure is applied. This fluid filled lenslet array can provide very low focal lengths. Another approach to obtain a switchable lenslet array is to use a Bragg grating lenslet array. That is, the switchable lenslet array can be based on using Bragg grating hologram technology to generate a switchable or non-switchable diffractive lenslet array. If the diffractive lenslet array is switchable, then an electric field can be applied, forcing the liquid crystal (LC) molecules to align opposite their anchoring alignment, and deactivate the lens. A lower electric field can be applied, placing the LC in an alternative alignment, effectively lowering the optical lens power. These are only a few examples of many possible examples that are known to persons skilled in the art and omitted for the sake of brevity.

The display device 34 enables the user's eye 40 to view an augmented reality because light from the physical world can propagate through the display device 34 towards the user's eye 40 while the light sources 36 display an image superimposed on the user's view of the physical world. Specifically, when the light sources 36 are emitting light, the lenslets 38-1 through 38-5 can be activated to render the digital image such that the user's eye 40 can perceive the superimposed digital image on the physical world. For example, the display device 34 can render holograms superimposed on a user's perception of the physical world. Hence, the user's eye 40 can perceive an augmented reality. Moreover, the display device 34 can modify the transparency of a hologram by changing a voltage or current applied to the light sources 36. Further still, the display device 34 can change a voltage applied to the lenslet to modify the optical effect of that lenslet.

In some embodiments, the display device 34 can include a switchable light blocking element 48 (e.g., a dimming panel) that blocks light from entering the display device 34. When the light blocking element 48 is activated, the user's eye 40 can perceive a virtual reality view because only the digital images being displayed by the display device 36 are visible to the user's eye 38, because the light from the physical world is blocked from entering the display device 34.

The display device 34 may be coupled to one or more controllers (not shown) that control the lenslet array 38, the light sources 36, and the light blocking element 48. For example, the controllers can activate or deactivate the light sources 36, lenslets 38, and light blocking element 48 to render a digital image on a certain plane. Specifically, a controller can decode image data and cause the display device 34 to display an image based on the image data by activating particular lenslets and/or light sources to allow a user to perceive the given image in a given location. In certain embodiments, entire sections of light sources can be kept off depending on the user's eye position, which saves energy.

The display device 34 may include an eye tracker 50. The eye tracker 50 can include an image capturing device that can capture images of a user's pupil to generate position signals representing a position of the pupil. In other embodiments, the eye tracker can capture the reflectance of the cornea or sclera to generate gaze vectors. In some embodiments, the eye tracker 50 can include a camera located on the side of the display device 34 or can be embedded in the display device 34. Therefore, the eye tracker 50 can track the position of the user's pupil, to identify which light sources 36 to turn on and where to steer beams of light into the user's eye 40, which improves perception that depends on interpupillary distance (IPD) of the eyes and their movement.

The controllers can operate to render an image in different display areas based on position signals generated by the eye tracker 50 such that light of a displayed image in a particular position is directed by specified lenslets associated with the display area to propagate through a position that coincides with the position of the pupil of the user's eye 40. Thus, using the eye tracker 50 allows for dynamically setting the position of an exit pupil coincident with the user's actual pupil such that the light emitted by the light sources 36 is directed to the position of the pupil of the user's eye 40. Accordingly, the user's eye 40 receives the light emitted by the display device 34 at any time even when the user's eye 40 is moving. Moreover, the position of an exit pupil can be set electronically and optically, which avoids the risk of mechanical failure. Lastly, the controller can modulate the power of a refractive geometric lens (e.g., refractive lenslets) to allow changing the optical power of said lenslet, modulating the perceived distance of the digital object.

When the light sources 36 are emitting light, the light from the real world may be obstructed or perturbed. However, in some embodiments, the lenslet array 38 can be tuned such that only a very small spectral bandwidth and/or area will be perturbed. In some cases, the display device 34 may operate in certain limited light spectrums. For example, the light sources 36 may have a limited emission bandwidth and/or the lenslets 36 may have a limited transmission bandwidth. As such, the light sources 36 may only emit light within a specified emission spectrum and the lenslets 38 may only transmit light within a specified transmission spectrum. The emission spectrum and the transmission spectrum can have varying degrees of overlap depending on a particular application. For example, the emission spectrum may equal the transmission spectrum such that all the light emitted by the light sources 36 is transmitted through the lenslets 38, and light outside the emission spectrum is blocked by the lenslets 38.

Although the real world view may be perturbed when a hologram is switched on, using switchable pixelated dimming may offer a solution to this problem. That is, a relationship exists between the offset of the hologram from the display, the pixel count, and distance from the stop (e.g., user's eye). Since the stop is larger than the pixel, the display source cannot seem like it is from infinity, and there is a limit to how far out it is possible to put the virtual image at. To mitigate these drawbacks, a switchable pixelated dimming display could be positioned following substrate 60 (e.g., dimming panel 48).

When the lenslets 64 are active, the real world beyond them could be temporarily dimmed to minimize the transmittance of the distorted real world view. For example, a pixelated dimming panel 48 could darken selected pixels. The dimming panel 48 can be formed from various display technologies, such as electrochromic, electrofluidic, and LCDs. In certain embodiments, the LCD variant can be a monochrome version of the color display technology used for mobile phones, monitors, and other applications. Electrochromic and electrofluidic display technologies can be used to make dimmable smart window glass and other optical switching devices. Alternatively, positive and negative compensation lenses can be used. This could further push out the perceived closeness of the display.

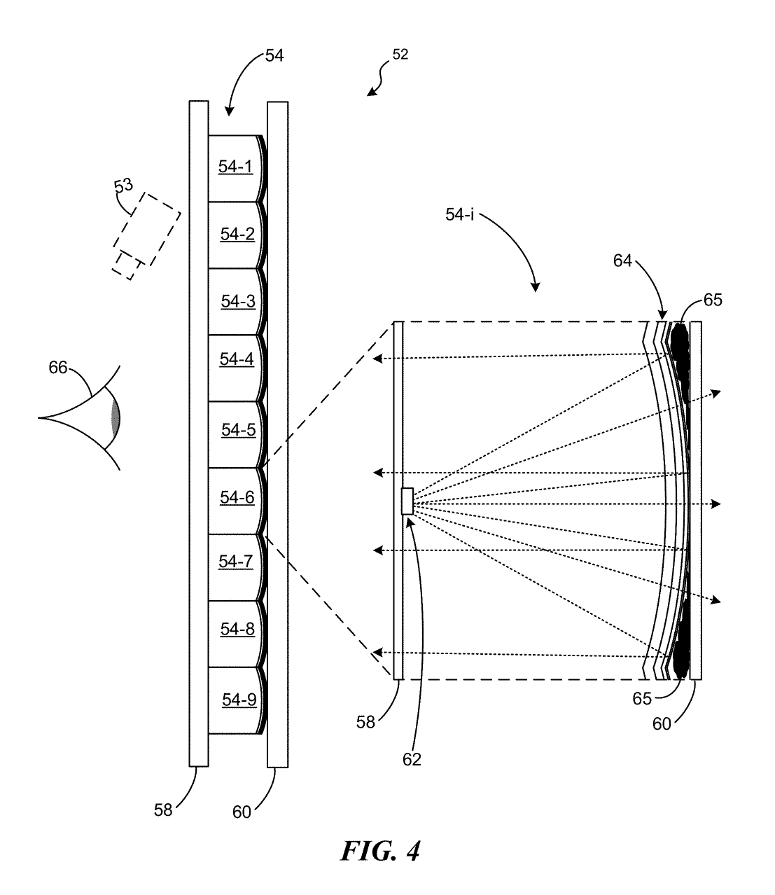

FIG. 4 is a schematic side view of a display device that has a reflection configuration where light sources emit light away from a user's eye and a lenslet array reflects the emitted light back towards the eye according to another embodiment of the disclosure. In some embodiments, the lenslet array could be a switchable lenslet array that is filled with an index matching fluid or could be a diffractive Bragg lens (e.g., switchable Bragg Grating (SBG)). FIG. 4 shows some components to aid in understanding the illustrated embodiment and omits other components that are known to persons skilled in the art and/or described elsewhere in this disclosure. For example, the display device 52 can include an eye tracker 53 similar to eye trackers described with reference to other embodiments. The display device 52 can be relatively thin and is at least somewhat transparent. In some embodiments, the display device 52 can be a peripheral display device that extends a user's FOV when combined with another display device included in an HMD device worn by the user.

As shown, the display device 52 includes rendering elements 54-1 through 54-9 disposed between two substrates 58 and 60. FIG. 4 also shows an enlarged illustration of a rendering element 54 including a single light source 62 that emits light in a divergent manner towards a lenslet 64. As such, the stack of rendering components 54-1 through 54-9 collectively form an array of light sources and a lenslet array. In some embodiments, the lenslets 64 reflect at least some light emitted by the light sources 62 and are indexed matched such that a user's perception of the outside world is not distorted when looking through the display device 52 while the light sources are not emitting light. For example, the index matching can compensate for the index mismatch between the air layer and a substrate, which would cause Fresnel reflections that would be noticeably non-transparent to the user. When the light sources 62 are emitting light onto the lenslets 64, a reflected component of the emitted light is collimated in a similar manner as described above with respect to other embodiments, to render an augmented or virtual view of reality to a user.

In some embodiments, the substrates 58 or 60 can be made of glass, plastic, or any other suitable transparent material, and may include electronic traces interconnecting various transparent electronic components known to persons skilled in the art. The substrates 58 and 60 may each have the same width (e.g., 0.55 mm), and a uniform spacing between the substrates 58 and 60 (e.g., less than 1.80 mm). A gap between the substrate 60 and the lenslets 64 may be filled with an index-matching substance 65 (e.g., fluid or adhesive) that provides the indexed matching of the display device 52. For example, the index matching substance 65 could match the index of substrate 60, and could match (and cancel out) all the irregularities that are unintended and could add optical power or cause scattering.

Examples of the light source 62 include OLEDs or ILEDs disposed on the substrate 58. In some embodiments, the use of ILEDs is beneficial over other LEDs because ILEDs have a smaller footprint (e.g., 50 by 50 microns) on the substrate 58 and are relatively more energy efficient. The light sources 62 may be sufficiently spaced apart (e.g., by 1 mm gap) to enable light to propagate through the display device 52. The light sources 62 of the rendering elements 54 can be controlled independently or simultaneously to fill a user's FOV. As such, the ILEDs of the display device 52 can form a semi-transparent micro display because the spacing between the ILEDs is relatively large.

The lenslets 64 include a reflective coating that can collimate the reflected light and send it to the user's eye 66. More specifically, the lenslets 64 are coated with a reflective substance causing at least a portion of the light emitted from the light source 62 to be reflected back to the user's eye 66, and another portion of the light can propagate through the substrate 60 to an external environment. For example, the reflective coating on the lenslet 64 may reflect half, no more than half, or less than half the light emitted by the light source 62, and allow the remaining half to transmit to the external environment. This configuration gives the user the perception that a point source is at optical infinity. Additionally, the power of the lenslet can be designed to make the user perceive that the source is coming from a finite distance away, rather than from infinitely far away.

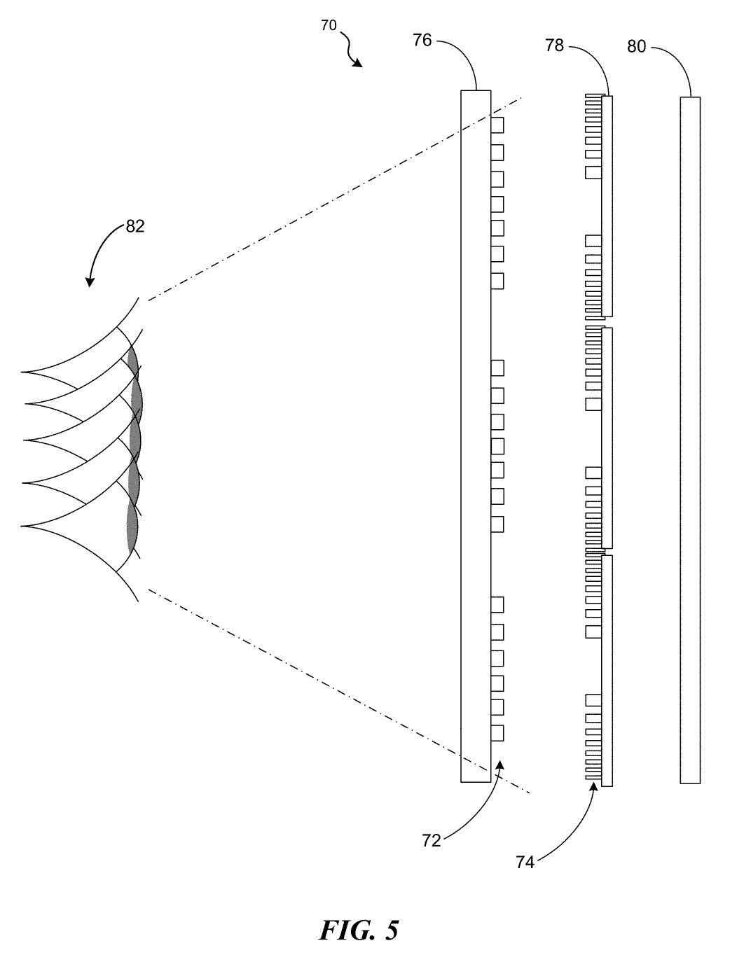

FIG. 5 is a schematic side view of a display device that has a reflection configuration and implements an eye box according to an embodiment. The display device 70 is depicted in the context of implementing a range of exit pupils. The range of exit pupils can be referred to as the eye-box. Similar to the display device 52 FIG. 4, the display device 70 includes light sources 72 and lenslets 74 disposed between two substrates 76 and 78. In this embodiment, the light sources 72 are grouped in clusters that are sufficiently spaced apart to enable light to propagate across the substrate 76. The lenslets 74 are shown as binary phase Fresnel lenses. The display device 70 also includes an optional light blocking element 80 similar to the light blocking element 48 of FIG. 3A. The illustrated display device 70 can include many of the same components as those discussed elsewhere in this disclosure and, as such, those components and related descriptions are not reproduced again. Instead, a person skilled in the art would understand how the disclosed embodiments could implement the eye-box based on the description of FIG. 5.

The eye-box represents a 2D region in which a user's eye can move and still perceive a displayed image. Specifically, the eye-box 82 defines a range of exit pupils of the display device 70. The user's eye can move anywhere within the range of the eye-box 82 and still perceive a displayed image. The eye-box 82 is formed by repeating displayed content periodically, which is achieved by using display elements that are repeated periodically, such as the repeating rendering elements 54 of FIG. 4. More specifically, a lenslet array formed of the repeating lenslets 74 facilitates repeatedly rendering displayed images at the same time. Hence, the disclosed embodiments including a lenslet array and corresponding light sources facilitates forming an eye box.

Therefore, the eye-box 82 represents the range within which a user's eye can be positioned to perceive content being rendered by the display device 70. In some embodiments, each replica of a digital image can be offset by a pixel to achieve an effectively higher interlaced resolution. The use of an eye-box allows for adjustment for varying IPDs without needing to make mechanical adjustments to the display device 70 that are typically necessary for different users using the same display device. That is, existing systems may attempt to compensate for the uniqueness of different users using the same display device with a mechanical adjustment system that is complex, inefficient, and prone to failure. Moreover, using an eye-box reduces or eliminates the need to use an eye tracker to track the movement of the pupil of a user's eye because the display device can compensate for movements of the user's pupil within the range of the eye box.

The eye box 82 or similar functions can be implemented in any of the embodiments disclosed herein that include a lenslet array. For example, the nine rending elements 54 of display device 62 can replicate content periodically to create an eye box. In some embodiments, a HMD device can implement an eye-box for each of a user's left eye and right eye. In some embodiments, a display device can include one or more controllers that dynamically adjust content being rendered to adjust the eye-box as needed, to ensure that a user wearing the HMD device can perceive displayed content.

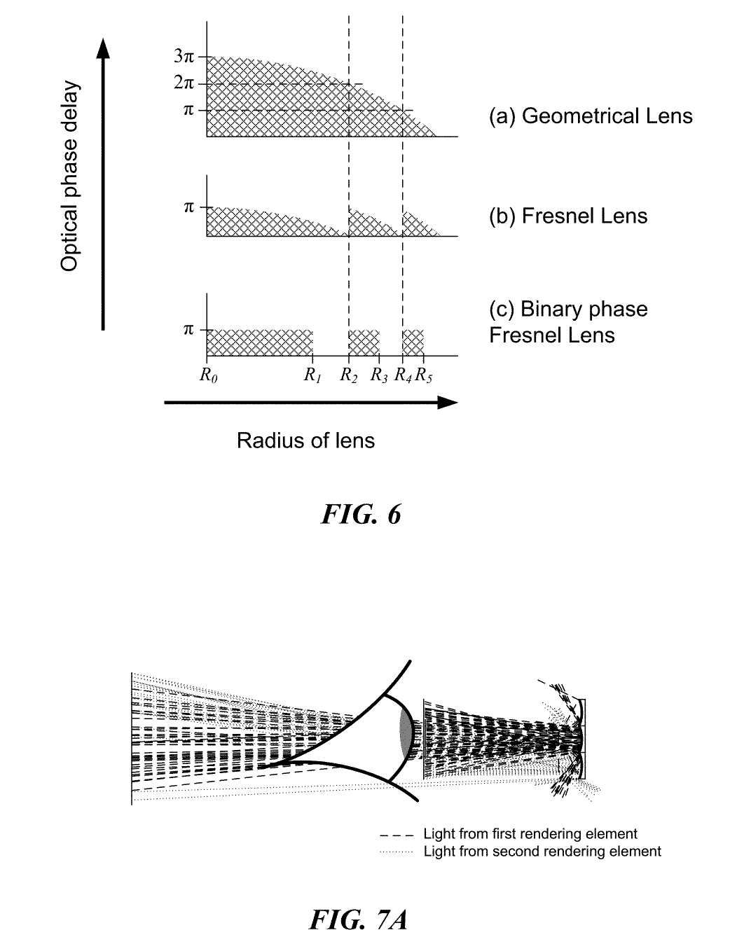

FIG. 6 is a graph showing properties of different types of lenses which could be implemented in the disclosed embodiments. In particular, FIG. 6 shows (a) a geometric lens, (b) a Fresnel lens, and (c) a binary phase Fresnel lens. The graph shows the optical phase delay as a function of the radius for each of these three different lenses that can be implemented in the lenslet arrays of the disclosed embodiments.

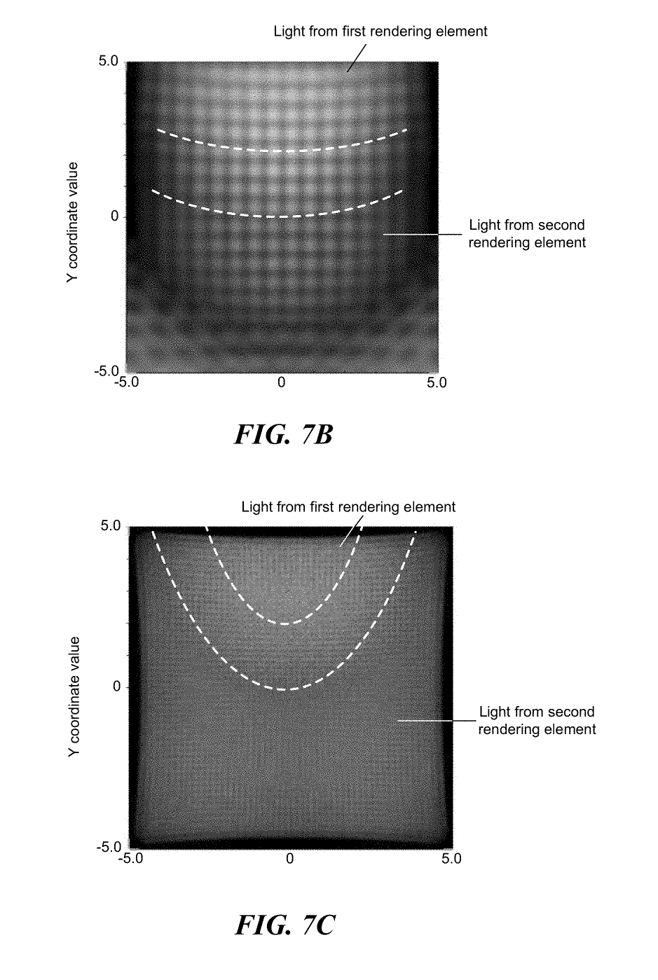

FIGS. 7A through 7B depict examples of an eye-box formed from two rendering elements according to an embodiment. As previously discussed above, a rendering element includes a light source and a corresponding lenslet that collectively operate to render content to a user's eye. For example, FIG. 7A depicts paths taken by light emitted by light sources and reflected off corresponding lenslets towards a user's eye. In particular, each of the two rendering elements includes a light source emitting light towards respective lenslets, which reflect a portion of that emitted light back toward the user's eye. FIG. 7B depicts an example of an eye-box created by two rendering elements of FIG. 7A. As shown, a first rendering element generates an illumination pattern between 0 and 5.0 on the Y-axis and a second rendering element generates an illumination pattern between 0 and −5.0 on the Y-axis. The illumination patterns of the two replication elements combine between the two illumination patterns. FIG. 7C similarly depicts the eye-box created from two replication elements of FIG. 7B.

The machine-implemented operations described above can be implemented at least partially by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a machine-readable storage medium and may be executed by one or more general-purpose or special-purpose programmable microprocessors. A “machine-readable medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random access memory (RAM), magnetic disk storage media, optical storage media, flash memory devices, etc.), among others.

The term “logic,” as used herein, means: a) special-purpose hardwired circuitry, such as one or more application-specific integrated circuits (ASICs), programmable logic devices (PLDs), field-programmable gate arrays (FPGAs), or other similar device(s); b) programmable circuitry programmed with software and/or firmware, such as one or more programmed general-purpose microprocessors, digital signal processors (DSPs) and/or microcontrollers, system-on-a-chip systems (SOCs), or other similar device(s); or c) a combination of the forms mentioned in a) and b).

### Examples of Certain Embodiments

Certain embodiments of the technology introduced herein are summarized in the following numbered examples:

1. A display device comprising: a plurality of substantially transparent substrates; a lenslet array including a plurality of substantially transparent lenslets disposed between the plurality of substantially transparent substrates; and a plurality of light sources disposed between the plurality of substantially transparent substrates, wherein the plurality of light sources are operable to emit light towards respective lenslets of the lenslet array, and the lenslet array is configured to render a digital image by reflecting the emitted light towards the plurality of light sources.

2. The display device of example 1, wherein each lenslet has a reflective surface configured to cause reflection of the emitted light towards the plurality of light sources.

3. The display device of example 1 or example 2, wherein the reflective surface is configured to allow a portion of light received from a respective light source to propagate through the lenslet without being reflected.

4. The display device of examples 1 through 3, wherein the portion of light is no more than half of the light received from a respective light source.

5. The display device of examples 1 through 4, wherein the lenslet array is an aperiodic lenslet array.

6. The display device of examples 1 through 5, wherein each lenslet is configured to collimate the emitted light reflected towards its respective light source.

7. The display device of examples 1 through 6, wherein the display device is configured to augment a field-of-view of another display device.

8. The display device of examples 1 through 7, wherein the display device is a first display device configured to augment a second display device having a greater resolution than the first display device.

9. The display device of examples 1 through 8, comprising: an index matching substance disposed between the lenslet array and an adjacent one of the plurality of substantially transparent substrates.

10. The display device of examples 1 through 9, wherein each lenslet is a Bragg-Fresnel lens or a Fresnel lens.

11. The display device of examples 1 through 10, wherein each light source is an inorganic light emitting diode.

12. The display device of examples 1 through 11, wherein the display device is configured to render the digital image based on position signals of a pupil of a user's eye generated by an eye tracker operable to capture images of the pupil, wherein the position signals are indicative of positions of the pupil relative to the display device.

13. The display device of examples 1 through 12, wherein the display device is configured to create an eye box region for rendering the digital image, the eye box region being created by respective combinations of a lenslet and respective light source collectively configured to display a repeating pattern of the digital image.

14. An HMD device comprising: a first display element; a second display element configured to augment the first display element, the second display element including: a plurality of substantially transparent substrates; a lenslet array including a plurality of substantially transparent lenslets disposed between the plurality of substantially transparent substrates; and a plurality of light sources disposed between the plurality of substantially transparent substrates, wherein the plurality of light sources are operable to emit light towards respective lenslets of the lenslet array, and the lenslet array is configured to render digital content by reflecting the emitted light towards the plurality of light sources.

15. The HMD device of example 14, wherein the first display element is positioned to project a portion of a digital image in front of a user's eye when the user is wearing the HMD device and the second display element is positioned to project another portion of the digital image on the periphery of the user's eye.

16. The HMD device of example 14 or example 15, wherein the first display element has a resolution greater than the second display element.

17. The HMD device of examples 14 through 16, wherein each light source is an inorganic light emitting diode.

18. The HMD device of examples 14 through 17, wherein the second display element comprises: an index matching substance disposed between the lenslet array and an adjacent one of the plurality of substantially transparent substrates.

19. The HMD device of examples 14 through 18, wherein the second display element is configured to create an eye box region for rendering a digital image, the eye box region being created by respective combinations of a lenslet and respective light source collectively configured to display a repeating pattern of the digital image.

20. An HMD device comprising: a substantially transparent main display element; a substantially transparent peripheral display element configured to extend a field of view of the main display element to include a peripheral view, the substantially transparent peripheral display element including: a lenslet array including a plurality of lenslets being electrically switchable to activate optical properties and deactivate the optical properties, wherein a lenslet is substantially transparent when deactivated; and a plurality of ILEDs configured to emit light towards respective lenslets, the plurality of ILEDs being sufficiently spaced apart such that the display is semi-transparent, wherein the lenslet array is configured to render a digital image when activated and receiving emitted light from the plurality of ILEDs.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A display device comprising:
a plurality of substantially transparent substrates;
a lenslet array including a plurality of substantially transparent lenslets disposed between the plurality of substantially transparent substrates; and
a plurality of light sources disposed between the plurality of substantially transparent substrates, wherein the plurality of light sources are operable to emit light towards respective lenslets of the lenslet array, and the lenslet array is configured to render a digital image by reflecting the emitted light towards the plurality of light sources.

2. The display device of claim 1, wherein each lenslet has a reflective surface configured to cause reflection of the emitted light towards the plurality of light sources.

3. The display device of claim 2, wherein the reflective surface is configured to allow a portion of light received from a respective light source to propagate through the lenslet without being reflected.

4. The display device of claim 3, wherein the portion of light is no more than half of the light received from a respective light source.

5. The display device of claim 1, wherein the lenslet array is an aperiodic lenslet array.

6. The display device of claim 1, wherein each lenslet is configured to collimate the emitted light reflected towards its respective light source.

7. The display device of claim 1, wherein the display device is configured to augment a field-of-view of another display device.

8. The display device of claim 1, wherein the display device is a first display device configured to augment a second display device having a greater resolution than the first display device.

9. The display device of claim 1, comprising:
an index matching substance disposed between the lenslet array and an adjacent one of the plurality of substantially transparent substrates.

10. The display device of claim 1, wherein each lenslet is a Bragg-Fresnel lens or a Fresnel lens.

11. The display device of claim 1, wherein each light source is an inorganic light emitting diode.

12. The display device of claim 1, wherein the display device is configured to render the digital image based on position signals of a pupil of a user's eye generated by an eye tracker operable to capture images of the pupil, wherein the position signals are indicative of positions of the pupil relative to the display device.

13. The display device of claim 1, wherein the display device is configured to create an eye box region for rendering the digital image, the eye box region being created by respective combinations of a lenslet and respective light source collectively configured to display a repeating pattern of the digital image.

14. A head mounted display (HMD) device comprising:
a first display element;
a second display element configured to augment the first display element, the second display element including:
a plurality of substantially transparent substrates;
a lenslet array including a plurality of substantially transparent lenslets disposed between the plurality of substantially transparent substrates; and
a plurality of light sources disposed between the plurality of substantially transparent substrates, wherein the plurality of light sources are operable to emit light towards respective lenslets of the lenslet array, and the lenslet array is configured to render digital content by reflecting the emitted light towards the plurality of light sources.

15. The HMD device of claim 14, wherein the first display element is positioned to project a portion of a digital image in front of a user's eye when the user is wearing the HMD device and the second display element is positioned to project another portion of the digital image on the periphery of the user's eye.

16. The HMD device of claim 14, wherein the first display element has a resolution greater than the second display element.

17. The HMD device of claim 14, wherein each light source is an inorganic light emitting diode.

18. The HMD device of claim 14, wherein the second display element comprises:
an index matching substance disposed between the lenslet array and an adjacent one of the plurality of substantially transparent substrates.

19. The HMD device of claim 14, wherein the second display element is configured to create an eye box region for rendering a digital image, the eye box region being created by respective combinations of a lenslet and respective light source collectively configured to display a repeating pattern of the digital image.

20. A head mounted display (HMD) device comprising:
a substantially transparent main display element;
a substantially transparent peripheral display element configured to extend a field of view of the main display element to include a peripheral view, the substantially transparent peripheral display element including:
a lenslet array including a plurality of lenslets being electrically switchable to activate optical properties and deactivate the optical properties, wherein a lenslet is substantially transparent when deactivated; and
a plurality of inorganic light emitting diodes (ILEDs) configured to emit light towards respective lenslets, the plurality of ILEDs being sufficiently spaced apart such that the display is semi-transparent,
wherein the lenslet array is configured to render a digital image when activated and receiving emitted light from the plurality of ILEDs.
